(19) United States
(12) Patent Application Publication
(10) Pub. No.: US 2015/0269552 A1
(43) Pub. Date: Sep. 24, 2015

(54) MULTI-PARTY FUND DISBURSEMENT

(71) Applicant: Discover Financial Services LLC, Riverwoods, IL (US)

(72) Inventors: James Michael TEKULVE, Surprise, AZ (US); Scott Michael DEBOARD, Lake Villa, IL (US); Joseph SungChul KIM, Northbrook, IL (US); Mark Alan OTTO, Apache Junction, AZ (US); Catherine Virginia MADISON, Grayslake, IL (US)

(73) Assignee: Discover Financial Services LLC, Riverwoods, IL (US)

(21) Appl. No.: 14/222,148

(22) Filed: Mar. 21, 2014

(51) Int. Cl. G06Q 20/22; G06Q 20/40

(52) U.S. Cl. CPC G06Q 20/227; G06Q 20/405

(57) ABSTRACT

This disclosure describes systems and methods for disbursing funds to multiple parties. The system allows a payment processing system to distribute funds to multiple parties. The disbursement amounts are contained in a disbursement file. Disbursements can be made as a percentage of revenue of a particular transaction.

### BACKGROUND OF THE INVENTION

Merchants often accept non-cash forms of payment in exchange for goods or services. A consumer may use, for example, a credit card to pay for goods or services. Electronic transactions have become an everyday part of the economy via the financial services industry. Whether the use occurs in person or remotely (e.g., via the Internet or mobile), utilization of various electronic payment instruments by both consumers and businesses is huge and rapidly growing. Thus, more and more merchants are seeing these types of transactions becoming a larger piece of how they receive payments for the goods and services they provide.

Examples of electronic payment instruments may include, but are not limited to, credit cards, debit cards, prepaid cards, alternative payment products, and the like. In a traditional payment network, the merchant interfaces with an acquirer to upload approved transactions. The acquirer interfaces with a payment network, which calculates the settlement amount, fees and settles with the acquirer. Cleared transactions are forwarded to the issuer processor. However, in a traditional transaction, funds are typically disbursed to one party in the transaction.

### BRIEF SUMMARY OF THE INVENTION

This disclosure describes systems and methods for disbursing funds to multiple parties. In one embodiment, a method for disbursing funds to at least two parties is described. The method includes receiving, by a payment processing system, a sales data file, transmitted by an acquirer and containing clearing transactions with approved transactions between a consumer and a merchant. A settlement amount with the acquirer is calculated. The method includes transmitting the clearing transactions and settlement amount to an issuer processor associated with an issuer. A merchant fund disbursement file is received from the issuer processor, wherein the merchant fund disbursement file contains disbursement fund amounts for the merchant and the issuer. The acquirer is debited the disbursement fund amount. The issuer is credited the disbursement fund amount.

Another embodiment provides a non-transitory computer readable medium storing instructions for causing a payment processing system to distribute funds to at least two parties. The instructions include receiving, by a payment processing system, a sales data file, transmitted by an acquirer and containing clearing transactions with approved transactions between a consumer and a merchant. Instructions for calculating a settlement amount with the acquirer are provided. The clearing transactions and settlement amount are transmitted according to the instructions to an issuer processor associated with an issuer. The instructions provide for receiving a merchant fund disbursement file from the issuer processor, wherein the merchant fund disbursement file contains disbursement fund amounts for the merchant and the issuer. Additionally, the instructions provide for debiting the acquirer the disbursement fund amount and crediting the issuer the disbursement fund amount.

In another embodiment, a payment processing system for disbursing funds to at least two parties is provided. The payment processing system has a processor for executing instructions stored on a non-transitory computer readable medium. The instructions include receiving, by a payment processing system, a sales data file, transmitted by an acquirer and containing clearing transactions with approved transactions between a consumer and a merchant. Instructions for calculating a settlement amount with the acquirer are provided. The clearing transactions and settlement amount are transmitted according to the instructions to an issuer processor associated with an issuer. The instructions provide for receiving a merchant fund disbursement file from the issuer processor, wherein the merchant fund disbursement file contains disbursement fund amounts for the merchant and the issuer. Additionally, the instructions provide for debiting the acquirer the disbursement fund amount and crediting the issuer the disbursement fund amount.

### BRIEF DESCRIPTION OF THE SEVERAL VIEWS OF THE DRAWING(S)

FIG. 1 illustrates a system for distributing funds to multiple parties according to one embodiment.

FIG. 2 is a flow chart illustrating the disbursement of funds to multiple parties according to one embodiment.

FIG. 3 is a flow chart illustrating the disbursement of funds to multiple parties to facilitate social gifting according to one embodiment.

FIG. 4 is a schematic diagram showing hardware components of a payment processing system for disbursing funds to at least two parties according to one embodiment.

### DETAILED DESCRIPTION OF THE INVENTION

Embodiments of the disclosure provide systems and methods for processing payments and disbursing funds to at least two parties. Embodiments provide a transmittal file including merchant fund disbursement amounts. The merchant fund disbursement amounts allow a payment processing system to distribute funds to multiple parties. For example, an issuer or program manager may receive a certain percentage of all transactions. Merchants may provide a gifting mechanism so that a portion of revenue can be shared with a charitable or other entity. Daily deal agents can partner with merchants to offer deals and coupons and directly receive a portion of the revenue from the merchant when the merchant accepts payment. Additionally, business-to-business transactions can take advantage of the disclosed system. A business could login to a procurement site and choose products and services from multiple suppliers. Using the disclosure, the business could pay for the products and services and funds would be distributed between the multiple suppliers and/or the procurement site.

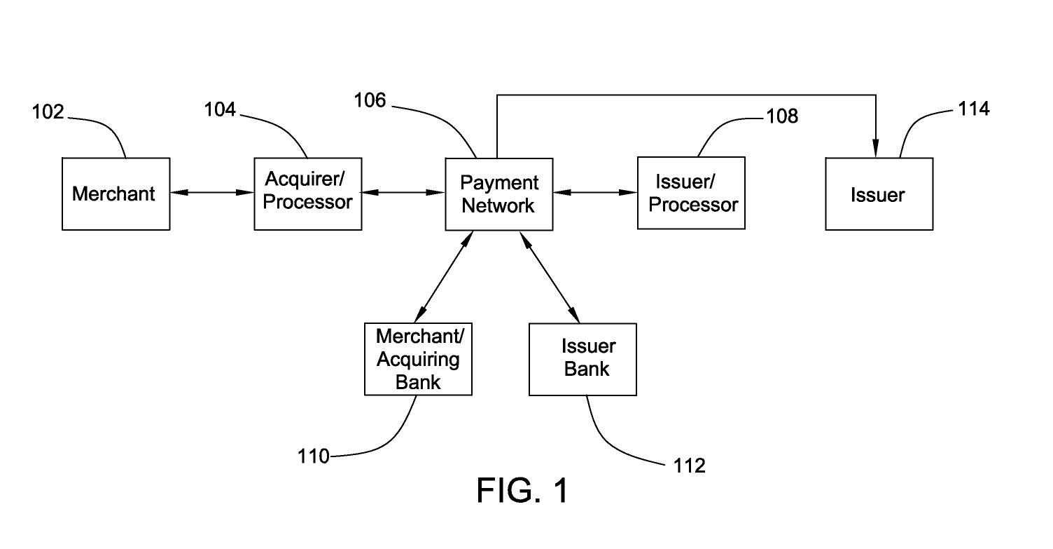

Turning to FIG. 1, a system for distributing funds to multiple parties according to one embodiment is disclosed. A merchant 102 accepts electronic payments for a transaction. Electronic payments include, but are not limited to, credit cards, debit cards, prepaid cards, gift cards, alternative payment products, and the like. This embodiment will be described with respect to a credit card, but other forms of payment apply as well.

A cardholder makes a purchase at the merchant 102. The merchant's approved transactions are uploaded to the acquirer/processor 104. The upload can happen immediately or in batches. In one embodiment, all approved transactions are uploaded from the merchant 102 to the acquirer/processor 104 at the end of the day. The acquirer/processor 104 then submits the transactions, known as clearing transactions, to the payment network 106 for settlement. In one embodiment, the acquirer/processor 104 groups transactions into a sales data file for submission to the payment network 106. The payment network 106 receives the clearing transactions and calculates the settlement amount and fees. The payment network 106 then settles with the acquirer/processor 104 and sends the settlement data and reports to the acquirer/processor 104.

The payment network 106 forwards the clearing transactions to the issuer processor 108. The payment network 106 calculates the settlement amount, fees, and/or interchange amount and settles with the issuer processor 108. The payment network 106 also sends the settlement data and reports to the issuer processor 108. The issuer processor 108 creates a payment data interface based on the transmittal file. The payment data interface contains merchant fund disbursement information. The payment data interface is sent from the issuer processor 108 to the payment network 106. The payment network 106 incorporates the merchant fund disbursement amounts into a settlement file settlement file sent to the acquirer/processor 104. The acquirer/processor 104 provides merchant statements detailing all transaction activity to the merchant 102.

All multi-party fund disbursements are net settled with acquirers as part of the settlement for the payment processor 106. Any fee credits and/or debits are passed to the issuer 114 by the payment network to debit or credit the amounts. In this way the merchant/acquiring bank 110 and the issuer bank 112 are credited and debited respectively for a purchase.

By way of example, on day 1 a consumer purchases fifty dollars worth of goods at merchant 102. Merchant 102 receives a credit for fifty dollars and the issuer 114 is debited for fifty dollars. In one embodiment, the issuer 114 and/or issuer processor 108 track a percentage of revenue that is owed to the issuer or program manager. For example, a particular website may act as a program manager and receive 5% of all revenue from sales made using a credit card issued in its name. The issuer processor 108 would track this and include a 5% revenue credit to the program manager in the payment data interface and a 5% credit to debit to the merchant.

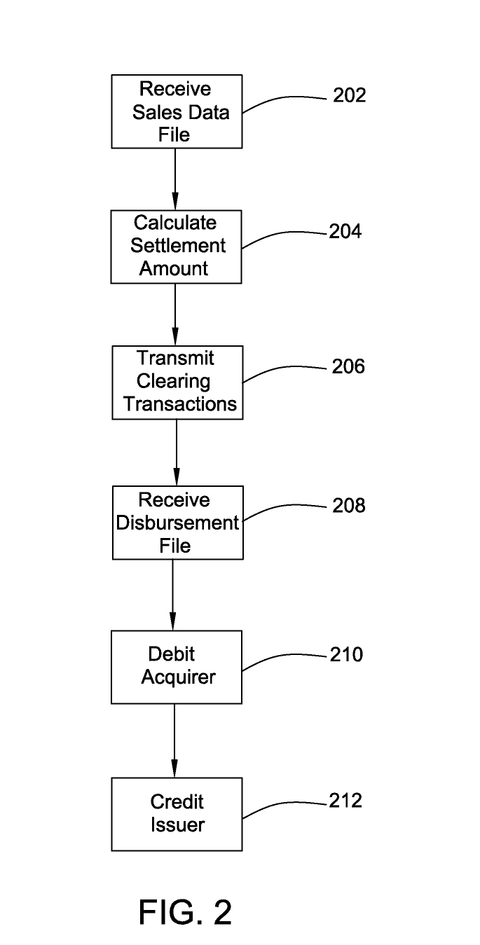

FIG. 2 is a flow chart illustrating the disbursement of funds to multiple parties according to one embodiment. A method for disbursing funds to at least two parties is shown. The method includes, at step 202, receiving, by a payment processing system, a sales data file, transmitted by an acquirer and containing clearing transactions with approved transactions between a consumer and a merchant. At step 204, a settlement amount with the acquirer is calculated. At step 206, the clearing transactions and settlement amount are transmitted to an issuer processor associated with an issuer. At step 208, a merchant fund disbursement file is received from the issuer processor, wherein the merchant fund disbursement file contains disbursement fund amounts for the merchant and the issuer. At step 210, the acquirer is debited the disbursement fund amount. The issuer is credited the disbursement fund amount at step 212.

While the embodiment in FIG. 2 illustrates disbursing funds between two parties, embodiments allow disbursing funds between additional parties. For example, the merchant fund disbursement file may contain multiple parties to credit and one party to debit with specific amounts or percentages to credit and debit based on, for example, revenue.

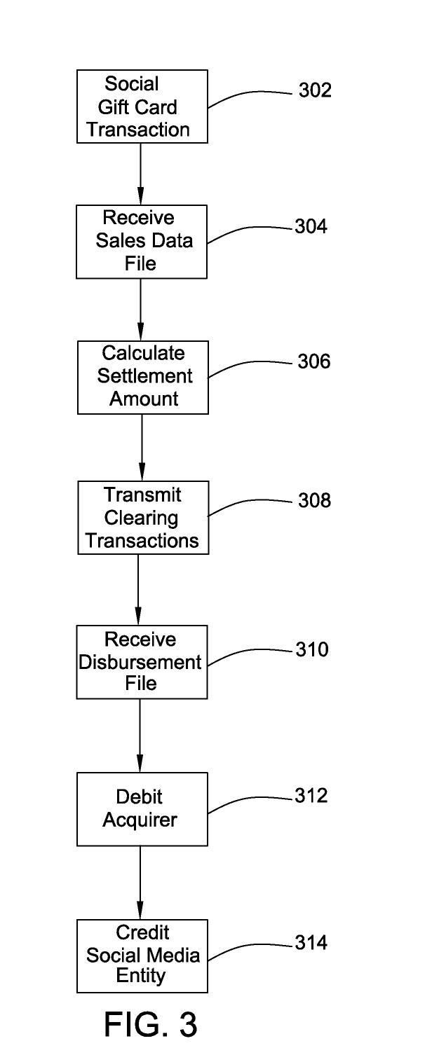

FIG. 3 is a flow chart illustrating the disbursement of funds to multiple parties to facilitate social gifting according to one embodiment. In this embodiment, a social media entity (or other entity), partners with various merchants to offer a gifting mechanism through the social media website. The merchant agrees to share a portion of the revenue with the social media entity.

At step 302, a transaction is made with a social gift card at a merchant. At step 304, a payment processing system receives a sales data file, transmitted by an acquirer and containing clearing transactions with approved transactions between the consumer and a merchant. At step 306, a settlement amount with the acquirer is calculated. At step 308, the clearing transactions and settlement amount are transmitted to an issuer processor associated with an issuer. At step 310, a merchant fund disbursement file is received from the issuer processor, wherein the merchant fund disbursement file contains disbursement fund amounts for the merchant and the issuer. In this embodiment, the social media website acts as the issuer. At step 312, the acquirer is debited the disbursement fund amount. The issuer, in this case the social media website, is credited the disbursement fund amount at step 314.

In other embodiments, business-to-business transactions are facilitated. For example, a business may log onto a procurement site and choose products and/or services needed by the business. Multiple suppliers may provide these products. The procurement site allows for invoices to be created for the agreed-upon terms and price. Payment of the invoices can be accomplished using the multi-party fund disbursement disclosure. Using the disclosure, the business could pay for the products and services and funds would be distributed between the multiple suppliers and/or the procurement site.

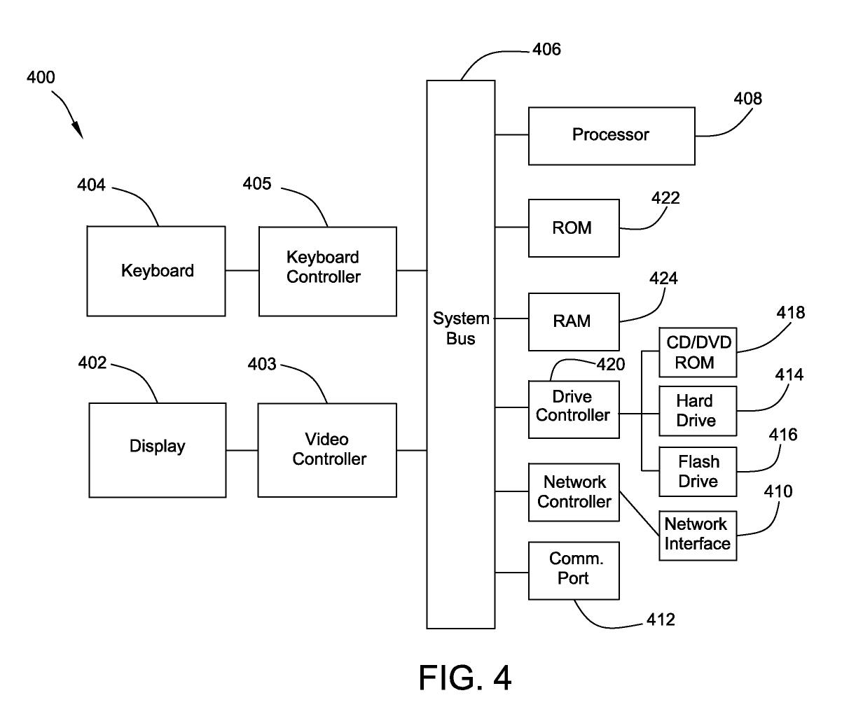

FIG. 4 is a schematic diagram showing hardware components of a payment processing system for disbursing funds to at least two parties according to one embodiment. Those skilled in the art will realize that the payment network 106 may include one or more computing devices described herein. The computing device 400, such as a computer, including a dedicated special-purpose support management device, includes a plurality of hardware elements, including a display 402 and a video controller 403 for presenting to the user an interface for interacting with the system. The computing device 400 further includes a keyboard 404 and keyboard controller 405 for relaying the user input via the user interface. Alternatively or in addition, the computing device 400 includes a tactile input interface, such as a touch screen. The display 402 and keyboard 404 (and/or touch screen) peripherals connect to the system bus 406. A processor 408, such as a central processing unit (CPU) of the computing device or a dedicated special-purpose support management processor, executes computer executable instructions comprising embodiments of the support management system, as described above. In embodiments, the computer executable instructions are received over a network interface 410 (or communications port 412) or are locally stored and accessed from a non-transitory computer readable medium, such as a hard drive 414, flash (solid state) memory drive 416, or CD/DVD ROM drive 418. The computer readable media 414-418 are accessible via the drive controller 420. Read Only Memory (ROM) 422 includes computer executable instructions for initializing the processor 408, while the Random Access Memory (RAM) 424 is the main memory for loading and processing instructions executed by the processor 408. The components illustrated in FIG. 1 can be implemented in one computing device or multiple computing devices connected over a network. Additionally, the computing device acquirer 104, issuer processor 106 and banks 112 may also use hardware components such as those illustrated in FIG. 4.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for disbursing funds to at least two parties, the method comprising:
receiving, by a payment processing system, a sales data file, transmitted by an acquirer and containing clearing transactions with approved transactions between a consumer and a merchant;
calculating a settlement amount with the acquirer;
transmitting the clearing transactions and settlement amount to an issuer processor associated with an issuer;
receiving a merchant fund disbursement file from the issuer processor, wherein the merchant fund disbursement file contains disbursement fund amounts for the merchant and the issuer;
debiting the acquirer the disbursement fund amount; and
crediting the issuer the disbursement fund amount.

2. The method of claim 1 further comprising providing a merchant statement to the merchant.

3. The method of claim 1 wherein the debiting is performed on a periodic basis.

4. The method of claim 3 wherein the periodic basis is once per day.

5. The method of claim 1 wherein the merchant is a supplier of products to a business.

6. The method of claim 1 wherein the approved transaction was made with a gift card.

7. The method of claim 1 wherein the sales data file is received on a periodic basis.

8. The method of claim 7 wherein the periodic basis is once per day.

9. A non-transitory computer readable medium storing instructions for causing a
payment processing system to distribute funds to at least two parties, the
instructions comprising:
receiving, by a payment processing system, a sales data file, transmitted by an acquirer and containing clearing transactions with approved transactions between a consumer and a merchant;
calculating a settlement amount with the acquirer;
transmitting the clearing transactions and settlement amount to an issuer processor associated with an issuer;
receiving a merchant fund disbursement file from the issuer processor, wherein the merchant fund disbursement file contains disbursement fund amounts for the merchant and the issuer;
debiting the acquirer the disbursement fund amount; and
crediting the issuer the disbursement fund amount.

10. The instructions of claim 9 further comprising instructions for providing a merchant statement to the merchant.

11. The instructions of claim 9 wherein the debiting is performed on a periodic basis.

12. The instructions of claim 11 wherein the periodic basis is once per day.

13. The instructions of claim 9 wherein the merchant is a supplier of products to a business.

14. The instructions of claim 9 wherein the approved transaction was made with a gift card.

15. The instructions of claim 9 wherein the sales data file is received on a periodic basis.

16. The instructions of claim 15 wherein the periodic basis is once per day.

17. A payment processing system for disbursing funds to at least two parties, the
payment processing system having a processor for executing instructions stored
on a non-transitory computer readable medium, the instructions comprising:
receiving, by a payment processing system, a sales data file, transmitted by an acquirer and containing clearing transactions with approved transactions between a consumer and a merchant;
calculating a settlement amount with the acquirer;
transmitting the clearing transactions and settlement amount to an issuer processor associated with an issuer;
receiving a merchant fund disbursement file from the issuer processor, wherein the merchant fund disbursement file contains disbursement fund amounts for the merchant and the issuer;
debiting the acquirer the disbursement fund amount; and
crediting the issuer the disbursement fund amount.

18. The payment processing system of claim 17 further comprising instructions for providing a merchant statement to the merchant.

19. The payment processing system of claim 17 wherein the debiting is performed on a periodic basis.

20. The payment processing system of claim 17 wherein the sales data file is received on a periodic basis.
